(19) United States
(12) Patent Application Publication
(10) Pub. No.: US 2014/0281439 A1
(43) Pub. Date: Sep. 18, 2014

(54) HARDWARE OPTIMIZATION OF HARD-TO-PREDICT SHORT FORWARD BRANCHES

(71) Applicant: QUALCOMM INCORPORATED, San Diego, CA (US)

(72) Inventors: Vimal K. Reddy, Raleigh, NC (US); Niket K. Choudhary, Raleigh, NC (US); Michael William Morrow, Wilkes-Barre, PA (US)

(73) Assignee: QUALCOMM INCORPORATED, San Diego, CA (US)

(21) Appl. No.: 13/832,119

(22) Filed: Mar. 15, 2013

(51) Int. Cl. G06F 9/38

(52) U.S. Cl. CPC G06F 9/38
USPC 712/239

(57) ABSTRACT

Methods and apparatuses for optimizing hard-to-predict short forward branches. A method detects a forward conditional branch with at least one instruction between the forward conditional branch and forward conditional branch target. The method determines whether a first of the at least one instruction includes at least one of a conditional branch or a condition-code setter. If the first instruction does not have the at least one of a conditional branch or a condition-code setter, the first instruction is dynamically assigned an inverted condition to optimize a code path. The method determines if there is a next instruction between the forward conditional branch and its target. If there is, the method analyzes the next instruction. If there is no next instruction, the method executes the optimized code path. If the instruction includes the conditional branch or condition-code setter, it discards dynamic assignments and executes the detected forward conditional branch.

### FIELD OF DISCLOSURE

Disclosed embodiments relate to optimizing short forward branches. More particularly, exemplary embodiments are directed to optimizing hard-to-predict short forward branches.

### BACKGROUND

High-performance microprocessors may be deeply pipelined, and execute several instructions speculatively by predicting the resolution of branch instructions. However, if the branch predictions are incorrect, cycles are lost in flushing speculative instructions, and fetching and executing correct instructions. This lowers performance and hence, mitigating the branch misprediction penalty is of great importance in high-performance microprocessors. For example, if the pipeline throughput is one instruction per cycle, and there is a ten-cycle branch misprediction penalty, then one misprediction per 1000 instructions is roughly a 1% loss in performance.

One approach to minimizing branch misprediction penalties attempts simply to reduce the number of branch instructions. Since branch misprediction can only occur on a branch instruction, a code sequence with no branch instructions can never be mispredicted.

A current method for reducing the number of branch instructions in a code sequence includes the use of predicated instructions. A predicated instruction is an instruction that performs a function if a condition that is specified in the predicated instruction is satisfied. If the condition is not satisfied, the instruction is treated as a NOP.

Predicated instructions can beneficially replace a code sequence that includes a condition setting instruction followed by a conditional branch instruction and a short code sequence that is executed depending upon the status of the condition. In such a sequence, the conditional branch is used to branch around the relatively short code sequence depending upon the state of the condition. In the predicated instruction implementation of such a code sequence, the conditional branch statement is eliminated and each of the instructions in the short code sequence is replaced with a predicated instruction.

There are current hardware solutions which try to mitigate the negative effects of branch mispredictions. Some solutions have looked at identifying hard-to-predict branches via confidence-based mechanisms and stalling the pipeline fetch on encountering such branches to save power. Sophisticated branch predictors have been designed to lower mispredictions, but they are complex to implement. Moreover, some types of branches are hard to predict, and therefore, branch prediction does not work well.

### SUMMARY

Exemplary embodiments of the invention are directed to systems and method for optimize hard-to-predict short forward branches according to exemplary embodiments.

For example, an exemplary embodiment is directed to a method for of optimizing a forward conditional branch, the method comprising: detecting a forward conditional branch with at least one instruction between the forward conditional branch and forward conditional branch target; and determining whether an instruction of the at least one instruction includes at least one of a conditional branch or a condition-code setter: if the instruction does not include the at least one of a conditional branch or a condition-code setter, dynamically assigning an inverted condition to the at least one instruction to optimize a code path, and determining whether there is a next instruction between the forward conditional branch and forward conditional branch target, if there is a next instruction, moving to the next instruction for analysis, if there is not a next instruction, executing the optimized code path, if the instruction includes either a conditional branch or a condition-code setter, discarding dynamically assigned inverted conditions on previously optimized instructions and executing the detected forward conditional branch.

Another exemplary embodiment is directed to an apparatus comprising: a branch detection circuit configured to detect a forward conditional branch with at least one instruction between the forward conditional branch and forward conditional branch target; an optimization determination circuit configured to determine if a first of the at least one instruction includes at least one of a conditional branch or a condition-code setter: a state machine configured to dynamically assign an inverted condition to the at least one instruction to optimize a code path if the instruction does not include the at least one of a conditional branch or a condition-code setter, and an instruction detector circuit configured to determine whether there is a next instruction between the forward conditional branch and forward conditional branch target; an instruction retrieval circuit configured to move to the next instruction for analysis if there is a next instruction, an execution circuit configured to execute the optimized code path if there is not a next instruction, an optimization discard circuit configured to discard dynamically assigned inverted conditions on previously optimized instructions and execute the detected forward conditional branch if the instruction includes the at least one of a conditional branch or a condition-code setter.

Yet another exemplary embodiment is directed to a processing system comprising: means for detecting a forward conditional branch with at least one instruction between the forward conditional branch and forward conditional branch target; means for determining whether a first of the at least one instruction includes at least one of a conditional branch or a condition-code setter: means for dynamically assigning an inverted condition to the at least one instruction to optimize a code path if the instruction does not include the at least one of a conditional branch or a condition-code setter, and means for determining whether there is a next instruction between the forward conditional branch and forward conditional branch target; means for moving to the next instruction for analysis if there is a next instruction, means for executing the optimized code path if there is not a next instruction, means for discarding dynamically, assigned inverted conditions on previously optimized instructions and executing the detected forward conditional branch if the instruction includes the at least one of a conditional branch or a condition-code setter.

Still another exemplary embodiment is directed to a non-transitory computer-readable storage medium comprising code, which, when executed by a processor, causes the processor to perform operations for switching between execution modes of the processor, the non-transitory computer-readable storage medium comprising: code for detecting a forward conditional branch with at least one instruction between the forward conditional branch and forward conditional branch target; code for determining whether a first of the at least one instruction includes at least one of a conditional branch or a condition-code setter: code for dynamically assigning an inverted condition to the at least one instruction to optimize a code path if the instruction does not include the at least one of a conditional branch or a condition-code setter, and code for determining whether there is a next instruction between the forward conditional branch and forward conditional branch target; code for moving to the next instruction for analysis if there is a next instruction, code for executing the optimized code path if there is not a next instruction, code for discarding dynamically assigned inverted conditions on previously optimized instructions and executing the detected forward conditional branch if the instruction includes the at least one of a conditional branch or a condition-code setter.

Another exemplary embodiment is directed to a method comprising: detecting a forward conditional branch with at least one instruction between the forward conditional branch and forward conditional branch target; retrieving an instruction; determining eligibility of the instruction for transformation or elimination; if the instruction is eligible for transformation or elimination; dynamically assigning an inverted condition to the instruction; and transmitting the modified instruction an execution core, if the instruction is not eligible for transformation or elimination, determining whether there is a next instruction between the forward conditional branch and forward conditional branch target; if there is a next instruction, retrieving the next instruction with predecode logic.

An additional exemplary embodiment is directed to an apparatus comprising: a branch detection circuit configured to detect a forward conditional branch with at least one instruction between the forward conditional branch and forward conditional branch target; an instruction retrieval circuit configured to retrieve an instruction; a predecode logic circuit configured to determine eligibility of the instruction for transformation or elimination; if the instruction is eligible for transformation or elimination: a state machine configured to dynamically assign an inverted condition to the instruction; and a transmitter configured to transmit the modified instruction an execution core, an instruction detector circuit configured to determine whether there is a next instruction between the forward conditional branch and forward conditional branch target if the instruction is not eligible for transformation or elimination; the instruction retrieval circuit configured to retrieve the next instruction with predecode logic if there is a next instruction.

Advantages of the present invention may include an elimination of a need for predicting hard-to-predict forward conditional branches with short offsets by leveraging predication facilities available in an ISA (e.g., condition codes in ARM). In some embodiments, the dynamic predication can reduce the effect of the forward conditional branch and remove any potential pipeline flushes from branch misprediction. In some embodiments, the method can leverage the already available hardware mechanisms that implement predication in an ISA.

### BRIEF DESCRIPTION OF THE DRAWINGS

The accompanying drawings are presented to aid in the description of embodiments of the invention and are provided solely for illustration of the embodiments and not limitation thereof.

FIG. 1A is a simplified schematic of a processing system configured according to exemplary embodiments.

FIG. 1B is a simplified schematic of another processing system configured according to exemplary embodiments.

FIG. 2 illustrates exemplary code sequences executed by a processor configured to optimize hard-to-predict short forward branches according to exemplary embodiments.

FIG. 3 illustrates an operational flow of a method for optimizing hard-to-predict short forward branches according to exemplary embodiments.

FIG. 4 illustrates an alternative operational flow of a method for optimizing hard-to-predict short forward branches according to exemplary embodiments.

FIG. 5 illustrates an example of code changes executed by a processor configured to optimize hard-to-predict short forward branches according to exemplary embodiments.

FIG. 6 illustrates an exemplary wireless communication system in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

With reference now to FIG. 1A, there is shown a simplified schematic of an exemplary processing system 100A. Processing system 100A is shown to comprise processor 102A coupled to memory 104A. While not illustrated, processing system 100A may comprise various other components such as one or more instruction and/or data caches, I/O devices, coprocessors, etc as are well known in the art. Memory 104A may be byte-addressable and comprise instructions to optimize hard-to-predict short forward branches. Processor 102A may be configured to execute instructions to optimize hard-to-predict short forward branches. For example, the processor 102A can eliminate or convert to a no-op (NOP) a forward conditional branch and make branched-over instructions conditional. The processor 102A can be disposed in various electronic devices, including a mobile device (e.g., a cellular telephone, a satellite telephone, a pager, a personal digital assistant (PDA), a smartphone), a Voice over IP (VoIP) device, a navigation device, an electronic book, a media player, a desktop computer, a laptop computer, and a gaming console.

In a non-limiting exemplary embodiment, instructions in memory 104A can allow the processor 102A to detect forward conditional branches (for e.g., with a condition EQ) with short forward targets, wherein a forward target is defined as target address>instr address. In some embodiments, a configuration register can be used to configure the short forward targets. A state machine 110A can then dynamically assign an inverted condition (e.g., using predecode logic to assign an EQ, or equal, instruction to an NE, or not equal, instruction) to each of the at least one instruction fetched following the branch until reaching the branch target address. This dynamic predication can eliminate the effect of the forward conditional branch and remove at least some of the potential pipeline flushes arising out of branch misprediction. If one of the at least one the instruction in the hard-to-predict short forward branch is a conditional branch itself or a condition-code setter, the processor 102A may not attempt to optimize the hard-to-predict short forward branch.

More specifically, a branch detection circuit 106A can detect a forward conditional branch with at least one instruction between the forward conditional branch and forward conditional branch target. An optimization determination circuit 108A can determine if a first of the at least one instruction includes at least one of a conditional branch or a condition-code setter.

If the instruction does not include the at least one of a conditional branch or a condition-code setter, a state machine 110A can dynamically assign an inverted condition to the at least one instruction to optimize a code path. An instruction detector circuit 112A can determine whether there is a next instruction between the forward conditional branch and forward conditional branch target. If there is a next instruction, an instruction retrieval circuit 114A can move to the next instruction for analysis. If there is not a next instruction, an execution circuit 116A can execute the optimized code path (e.g., the optimized branch).

If the instruction includes the at least one of a conditional branch or a condition-code setter, an optimization discard circuit 118A can discard dynamically assigned inverted conditions on previously optimized instructions and execute the detected for conditional branch.

With reference now to FIG. 1B, there is shown another simplified schematic of an exemplary processing system 100B. Instructions in memory 104B can allow a processor 102B to optimize hard-to-predict short forward branches. A branch detection circuit 106B can detect a forward conditional branch with at least one instruction between the forward conditional branch and forward conditional branch target. An instruction retrieval circuit 114B can retrieve an instruction. A predecode logic circuit 108B can determine eligibility of the instruction with predecode logic for transformation or elimination.

If the instruction is eligible for transformation or elimination, a state machine 110B can dynamically assign an inverted condition to the instruction. A transmitter 120B can transmit the modified instruction an execution core.

If the instruction is not eligible for transformation or elimination, an instruction detector circuit 112B can determine whether there is a next instruction between the forward conditional branch and forward conditional branch target if the instruction is not eligible for transformation or elimination. If there is a next instruction between the forward conditional branch and forward conditional branch target, the instruction retrieval circuit 114B can retrieve the next instruction with predecode logic if there is a next instruction.

With reference to FIG. 2, the example code 200 illustrates sequences executed by a processor configured to optimize hard-to-predict short forward branches according to exemplary embodiments. In some embodiments, the hardware alters instructions during fetch stages so that a branch is eliminated and therefore the hardware cannot mispredict the outcome. No program semantics are changed in this process (e.g., “BNE skip” changed to “NOP”).

Similar to FIG. 2, other embodiments of optimizing forward conditional branches can be implemented. TABLES 1 and 2 provide assembly code wherein TABLE 1 is assembly language prior to optimization and TABLE 2 is assembly language after optimization.

TABLE 1
Assembly code

LDR r6, [r3]
LDR r7, [r4]
Cmp r6, r7
pcA BEQ pcA+16=pcE
pcB ADD r8, r6
pcC SUB r7, r6
pcD MUL r8, 100
pcE ADD r7, 100

TABLE 2
Dynamic optimized code in hardware

LDR r6, [r3]
LDR r7, [r4]
Cmp r6, r7
pcA NOP (converted from BEQ pcA+16=pcE)
pcB ADDNE r8, r6
pcC SUBNE r7, r6
pcD MULNE r8, 100
pcE ADD r7, 100

It will be appreciated that embodiments include various methods for performing the processes, functions and/or algorithms disclosed herein. For example, as illustrated in FIG. 3, an embodiment can include a method of optimizing a forward conditional branch comprising: detecting a forward conditional branch (e.g., a hard-to-predict short forward branch) with at least one instruction between the forward conditional branch and forward conditional branch target (e.g., the instructions of the original code in FIG. 2)—Block 302; determining whether the instruction being analyzed includes the at least one of a conditional branch or a condition-code setter (e.g., an instruction that has conditions which disagree)—Block 304.

if the instruction being analyzed does not include the at least one of a conditional branch or a condition-code setter, dynamically assigning an inverted condition to the instruction being analyzed (e.g., dynamically assigning one of the at least one instruction into a NOP; for BNE, applying EQ to following instructions)—Block 306. If there is a next instruction between the forward conditional branch and forward conditional branch target (e.g. a second of at least two sequential instructions), moving to the next instruction for optimization until the last instruction has been analyzed—Block 308. If there is no next instruction, executing the optimized code path—Block 310.

Returning to block 304, if the instruction being analyzed is either a conditional branch or a condition-code setting instruction, the method proceeds to Block 312. The method further comprises discarding dynamically assigned inverted conditions on previously analyzed instructions—Block 312; and executing the detected forward conditional branch—Block 314.

In some embodiments, the at least one instruction can include a forward conditional branch that is a last branch in a branched-over block, and wherein the branch does not disqualify the invention from optimizing the block.

In FIG. 4, an alternative embodiment can include a method of optimizing a forward conditional branch comprising: detecting a forward conditional branch (e.g., a hard-to-predict short forward branch such that the short forward branch has fewer instructions for the number of cycles in the miss penalty) with at least one instruction between the forward conditional branch and forward conditional branch target (e.g., the instructions of the original code in FIG. 2)—Block 402; retrieving an instruction (e.g., an instruction that has conditions which disagree)—Block 404; determining whether the instruction is eligible for transformation or elimination—Block 406.

If the instruction is not eligible for transformation or elimination, determining whether there is a next instruction—Block 412; if there is a next instruction, retrieving next instruction—Block 404. If instruction is eligible for transformation or elimination, dynamically assigning an inverted condition to the instruction (e.g., dynamically assigning the instruction into an NOP; for BNE, applying EQ to following instructions)—Block 408; and transmitting the modified instruction to the execution core—Block 410.

Similar to the sequence of instructions in FIG. 2, FIG. 5 provides an exemplary diagram 500 showing how one embodiment can use predecode logic to annotate instructions eligible for transformation or elimination. In FIG. 5, a line in memory 502 can include five instructions: FOR 504a, BNE 506a, ADD 508a, SUB 510a, and LDR 512a. If the predecode logic 514 is applied, a line in an instruction cache 516 can include the following: FOR 504b; BNE 506b, ADD 508h, SUB 510b, and LDR 512b, each with a 1-bit annotation 504c-512c to either transform (1) or eliminate (0) the instruction. Once fetched, the branch can be NOP'ed and marked instructions can be transformed. For example, the contents of line 516 of the instruction cache may be input into a state machine to transform the BNE, ADD and SUB instructions into the appropriate transformed instructions, in this case NOP, EQADD and EQSUB respectively.

In some embodiments, the efficacy of the forward conditional branch prior to optimization may be evaluated after execution so as to compare it to the efficacy of the branch after optimization. In some embodiments, the forward conditional branch can be further optimized using software methods of optimization. For example,

In some embodiments, the forward conditional branch can be optimized prior to analysis. For example, the at least one instruction can have a condition that disagrees with the condition of the branch, and the at least one instruction can be dynamically assigned into a NOP. In some embodiments, forward conditional branch optimization is qualified by a branch-predictor state. Some examples of software forward conditional branch optimization include the biasing of a combination of AND and OR statements can be increased in software; the branches in a loop can be removed when the conditional does not change during the duration of the loop; and a branch target buffer (BTB) can be used to predict using a history log of previously encountered branches. In some embodiments, the forward conditional branch can be optimized only if a branch predictor has a weak state.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the aid will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative the storage medium may be integral to the processor.

Referring to FIG. 6, a block diagram of a particular illustrative embodiment of a wireless device that includes a multi-core processor configured according to exemplary embodiments is depicted and generally designated 600. The device 600 includes a digital signal processor (DSP) 664, which may include predecode logic 108B and state machine 110B of FIG. 1B coupled to memory 632 as shown. FIG. 6 also shows display controller 626 that is coupled to DSP 664 and to display 628. Coder/decoder (CODEC) 634 (e.g., an audio and/or voice CODEC) can be coupled to DSP 664. Other components, such as wireless controller 640 (which may include a modem) are also illustrated. Speaker 636 and microphone 638 can be coupled to CODEC 634. FIG. 6 also indicates that wireless controller 640 can be coupled to wireless antenna 642. In a particular embodiment, DSP 664, display controller 626, memory 632, CODEC 634, and wireless controller 640 are included in a system-in-package or system-on-chip device 622.

in a particular embodiment, input device 630 and power supply 644 are coupled to the system-on-chip device 622. Moreover, in a particular embodiment, as illustrated in FIG. 6, display 628, input device 630, speaker 636, microphone 638, wireless antenna 642, and power supply 644 are external to the system-on-chip device 622. However, each of display 628, input device 630, speaker 636, microphone 638, wireless antenna 642, and power supply 644 can be coupled to a component of the system-on-chip device 622, such as an interface or a controller.

It should be noted that although FIG. 6 depicts a wireless communications device, DSP 664 and memory 632 may also be integrated into a set-top box, a music player, a video player, an entertainment unit, a navigation device, a personal digital assistant (PDA), a fixed location data unit, or a computer. A processor (e.g., DSP 664) may also be integrated into such a device.

Accordingly, an embodiment of the invention can include a computer readable media embodying a method for optimizing hard-to-predict short forward branches. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of optimizing a forward conditional branch, the method comprising:
detecting a forward conditional branch with at least one instruction between the forward conditional branch and forward conditional branch target; and
determining whether an instruction of the at least one instruction includes at least one of a conditional branch or a condition-code setter:
if the instruction does not include the at least one of a conditional branch or a condition-code setter, dynamically assigning an inverted condition to the at least one instruction to optimize a code path, and
determining whether there is a next instruction between the forward conditional branch and forward conditional branch target,
if there is a next instruction, moving to the next instruction for analysis,
if there is not a next instruction, executing the optimized code path,
if the instruction includes the at least one of a conditional branch or a condition-code setter, discarding dynamically assigned inverted conditions on previously optimized instructions and executing the detected forward conditional branch.

2. The method of claim 1, wherein the method of optimizing forward conditional branches is qualified by a branch-predictor state.

3. The method of claim 2, wherein the detected forward conditional branch is optimized only if a branch predictor has a weak state.

4. The method of claim 1, further comprising evaluating, after execution of the optimized code path, the efficacy of the forward conditional branch prior to optimization.

5. The method of claim 1, wherein the forward conditional branch is further optimized using software methods of optimization.

6. The method of claim 1, wherein the forward conditional branch has been optimized prior to performing the method.

7. The method of claim 6, wherein the at least one instruction has a condition that disagrees with the condition of the branch, and the at least one instruction is dynamically assigned into a NOP.

8. The method of claim 1, wherein the at least one instruction includes a forward conditional branch that is a last branch in a branched-over block, and wherein the last branch does not disqualify the invention from optimizing the branched-over block.

9. The method of claim 1, wherein the forward conditional branch has a short forward target.

10. An apparatus comprising:
a branch detection circuit configured to detect a forward conditional branch with at least one instruction between the forward conditional branch and forward conditional branch target;
an optimization determination circuit configured to determine if a first of the at least one instruction includes at least one of a conditional branch or a condition-code setter:
a state machine configured to dynamically assign an inverted condition to the at least one instruction to optimize a code path if the instruction does not include the at least one of a conditional branch or a condition-code setter, and
an instruction detector circuit configured to determine whether there is a next instruction between the forward conditional branch and forward conditional branch target;
an instruction retrieval circuit configured to move to the next instruction for analysis if there is a next instruction,
an execution circuit configured to execute the optimized code path if there is not a next instruction,
an optimization discard circuit configured to discard dynamically assigned inverted conditions on previously optimized instructions and execute the detected forward conditional branch if the instruction includes the at least one of a conditional branch or a condition-code setter.

11. The apparatus of claim 10, wherein the forward conditional branch is further optimized using software methods of optimization.

12. The apparatus of claim 10, wherein optimizing forward conditional branches is qualified by a branch-predictor state.

13. The apparatus of claim 12, wherein the detected forward conditional branch is optimized only if a branch predictor has a weak state.

14. The apparatus of claim 10, wherein the forward conditional branch has been optimized prior to analysis.

15. The apparatus of claim 14, wherein there are at least two sequential instructions between the forward conditional branch and forward conditional branch target, wherein one of the at least two sequential instructions has conditions that disagree, and the one of the at least two sequential instructions is dynamically assigned into a NOP.

16. The apparatus of claim 10, wherein the forward conditional branch is a hard-to-predict short forward branch.

17. The apparatus of 10, wherein the apparatus is disposed in a processor.

18. The apparatus of claim 17, wherein the processor is disposed in at least one of a mobile device, a Voice over IP (VoIP) device, a navigation device, an electronic book, a media player, a desktop computer, a laptop computer, and a gaming console.

19. A processing system comprising:
means for detecting a forward conditional branch with at least one instruction between the forward conditional branch and forward conditional branch target;
means for determining whether a first of the at least one instruction includes at least one of a conditional branch or a condition-code setter:
means for dynamically assigning an inverted condition to the at least one instruction to optimize a code path if the instruction does not include the at least one of a conditional branch or a condition-code setter, and
means for determining whether there is a next instruction between the forward conditional branch and forward conditional branch target;
means for moving to the next instruction for analysis if there is a next instruction,
means for executing the optimized code path if there is no next instruction,
means for discarding dynamically assigned inverted conditions on previously optimized instructions and executing the detected forward conditional branch if the instruction includes the at least one of a conditional branch or a condition-code setter.

20. A non-transitory computer-readable storage medium comprising code, which, when executed by a processor, causes the processor to perform operations for switching between execution modes of the processor, the non-transitory computer-readable storage medium comprising:
code for detecting a forward conditional branch with at least one instruction between the forward conditional branch and forward conditional branch target;
code for determining whether a first of the at least one instruction includes at least one of a conditional branch or a condition-code setter:
code for dynamically assigning an inverted condition to the at least one instruction to optimize a code path if the instruction does not include the at least one of a conditional branch or a condition-code setter, and
code for determining whether there is a next instruction between the forward conditional branch and forward conditional branch target;
code for moving to the next instruction for analysis if there is a next instruction,
code for executing the optimized code path if there is no next instruction,
code for discarding dynamically assigned inverted conditions on previously optimized instructions and executing the detected forward conditional branch if the instruction includes the at least one of a conditional branch or a condition-code setter.

21. A method of optimizing a forward conditional branch, the method comprising;
detecting a forward conditional branch with at least one instruction between the forward conditional branch and forward conditional branch target;
retrieving an instruction;
determining eligibility of the instruction for transformation or elimination;
if the instruction is eligible for transformation or elimination:
dynamically assigning an inverted condition to the instruction; and
transmitting the modified instruction an execution core,
if the instruction is not eligible for transformation or elimination, determining whether there is a next instruction between the forward conditional branch and forward conditional branch target;
if there is a next instruction, retrieving the next instruction with predecode logic.

22. An apparatus comprising:
a branch detection circuit configured to detect a forward conditional branch with at least one instruction between the forward conditional branch and forward conditional branch target;
an instruction retrieval circuit configured to retrieve an instruction;
a predecode logic circuit configured to determine eligibility of the instruction for transformation or elimination;
if the instruction is eligible for transformation or elimination:
a state machine configured to dynamically assign an inverted condition to the instruction; and
a transmitter configured to transmit the modified instruction an execution core,
an instruction detector circuit configured to determine whether there is a next instruction between the forward conditional branch and forward conditional branch target if the instruction is not eligible for transformation or elimination;
the instruction retrieval circuit configured to retrieve the next instruction with predecode logic if there is a next instruction.
